(19) United States
(12) Patent Application Publication
(10) Pub. No.: US 2017/0154630 A1
(43) Pub. Date: Jun. 1, 2017

(54) ELECTRONIC DEVICE AND METHOD FOR INTERPRETING BABY LANGUAGE

(71) Applicants: Fu Tai Hua Industry (Shenzhen) Co., Ltd., Shenzhen (CN); HON HAI PRECISION INDUSTRY CO., LTD., New Taipei (TW)

(72) Inventor: YU ZHANG, Shenzhen (CN)

(21) Appl. No.: 15/088,660

(22) Filed: Apr. 1, 2016

(30) Foreign Application Priority Data
Nov. 27, 2015 (CN) 201510839891.4

(51) Int. Cl. G10L 17/26; G10L 15/18; G06K 9/72; G10L 17/14; G06K 9/00; G10L 25/87; G10L 15/24

(52) U.S. Cl. CPC G10L 17/26; G10L 25/87; G10L 15/1815; G10L 15/24; G10L 17/14; G06K 9/00302; G06K 9/00369; G06K 9/726

(57) ABSTRACT

In a baby language interpreting method, baby language from a baby is received; environment information of an environment where the baby is located upon receipt of the baby language is captured. The baby language information is recognized from the received baby language. The environment information is recognized. The recognized baby language information and the recognized environment information are compared to predefined baby language information and predefined environment information recorded in a predefined relationship table. The received baby language is interpreted into the semantic information described in adult language according to a comparison result. The interpreted semantic information described in adult language is presented to an adult user.

### CROSS-REFERENCE TO RELATED APPLICATIONS

This application claims priority to Chinese Patent Application No. 201510839891.4 filed on Nov. 27, 2015, the contents of which are incorporated by reference herein.

### FIELD

The subject matter herein generally relates to baby language recognition, and more specifically relates to an electronic device and a method for interpreting baby language.

### BACKGROUND

Generally, babies cry or babble (hereinafter baby language) to express their needs before they can speak adult language, which is hard for adults such as parents to understand.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of a hardware environment for executing a baby language interpretation system.

FIG. 2 is a block diagram of one embodiment of function modules of the baby language interpretation system in FIG. 1.

FIG. 3 is a flowchart of one embodiment of a baby language interpretation method.

FIG. 4 is a diagrammatic view of a first embodiment of a pre-defined relationship.

FIG. 5 is a diagrammatic view of a second embodiment of a pre-defined relationship.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Furthermore, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series and the like.

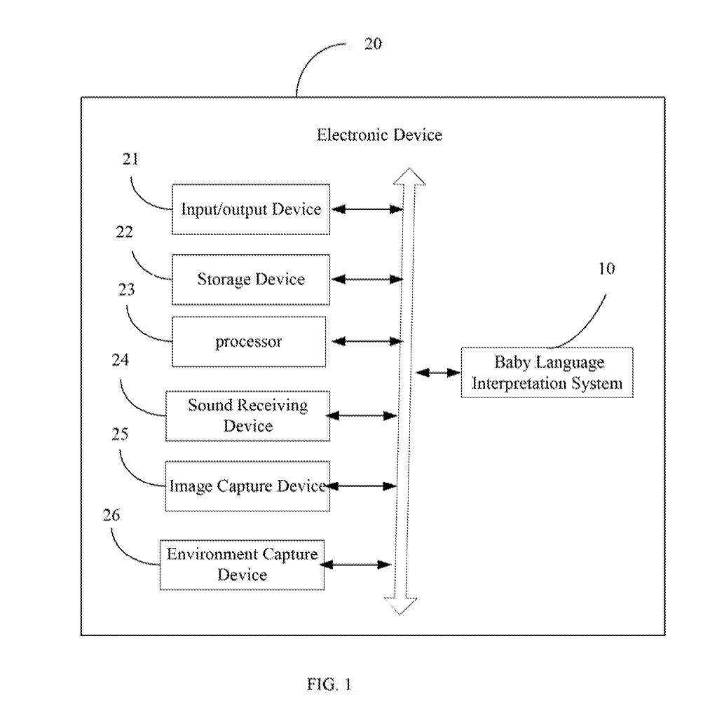

FIG. 1 is a block diagram of one embodiment of a hardware environment for executing a baby language interpretation system. The baby language interpretation system 10 (hereinafter referred as the interpretation system 10) is installed and runs in an apparatus, for example an electronic device 20. In at least one embodiment as shown in FIG. 1, the electronic device 20 includes, but is not limited to, an input/output device 21, a storage device 22, at least one processor 23, a sound receiving device 24, an image capture device 25, and an environment capture device 26. The electronic device 20 can be a tablet computer, a notebook computer, a smart phone, a personal digital assistant (PDA), or other suitable electronic device. FIG. 1 illustrates only one example of the electronic device; other can include more or fewer components than illustrated, or have a different configuration of the various components in other embodiments.

By utilizing the interpretation system 10, the electronic device 20 can receive baby language from a baby, and capture, upon receipt of the baby language, environment information of an environment where the baby is located. The interpretation system 10 can recognize baby language information from the received baby language. The interpretation system 10 can recognize the captured environment information. The interpretation system 10 compares the recognized baby language information and the recognized environment information with predefined baby language information and predefined environment information recorded in a predefined relationship table and interprets the received baby language into the semantic information described in adult language according to a comparison result. The interpretation system 10 presents the interpreted semantic information described in adult language to an adult user.

In at least one embodiment, the storage device 22 can include various types of non-transitory computer-readable storage mediums. For example, the storage device 22 can be an internal storage system, such as a flash memory, a random access memory (RAM) for temporary storage of information, and/or a read-only memory (ROM) for permanent storage of information. The storage device 22 can also be an external storage system, such as a hard disk, a storage card, or a data storage medium. The at least one processor 23 can be a central processing unit (CPU), a microprocessor, or other data processor chip that performs functions of the interpretation system 10 in the electronic device 20.

The sound receiving device 24 can receive baby language from a baby. The sound receiving device 24 can further receive, when the baby speaks the baby language, sound of an environment where the baby is located, hereinafter “environment sound”. The baby language includes all sound generated by the baby. In the illustrated embodiment, the sound receiving device 24 is a microphone.

The image capture device 25 can capture, upon receipt of the baby language, images of an area of the environment where the baby is located, hereinafter “environment images”. The position where the baby is located is taken as a center of the area, and a range which has a predetermined distance to the center is taken as boundary of the area, herein the distance from the boundary to the center equals to a predefined distance. For example, the distance can be 2 meters. The image capture device 25 can further capture images of the baby. The baby images include facial expression images of the baby and movement images of the baby body. Hereinafter, the information from the images of the baby is called “baby body language information”. In the illustrated embodiment, the image capture device 25 is a camera.

The input/output device 21 can generate commands in respond to user operations, or can display image or content to user. For example, the input/output device 21 can generate a first command for capturing images of the baby in response to a first operation. The input/output device 21 can generate a second command for receiving baby language in response to a second operation. The input/output device 21 can generate a third command for displaying captured images of the baby in response to a third operation. The input/output device 21 can generate a fourth command for broadcasting semantic information described in adult language corresponding to the received baby language. In the embodiment, the input/output device 21 can be a touch screen, which has functions of display and input. In an alternative embodiment, the input/output device 21 can include an input device, such as keyboard or touch panel, and a display device, such as display screen.

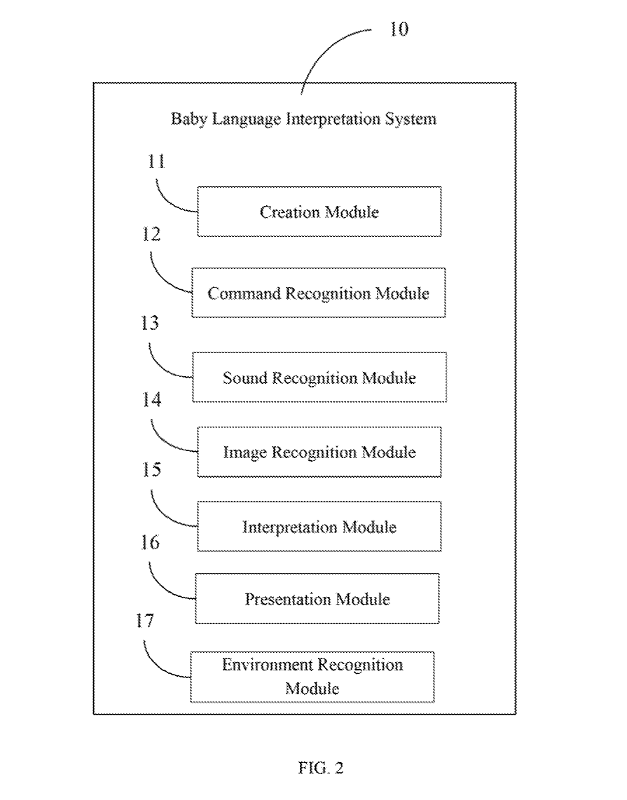

FIG. 2 is a block diagram of one embodiment of the function modules of the system. In at least one embodiment, the interpretation system 10 can include a creation module 11, a command recognition module 12, a sound recognition module 13, an image recognition module 14, an interpretation module 15, a presentation module 16, and an environment recognition module 17. The function modules 11-16 can include computerized codes in the form of one or more programs, which are stored in the storage device 22. The at least one processor 23 executes the computerized codes to provide functions of the function modules 11-16.

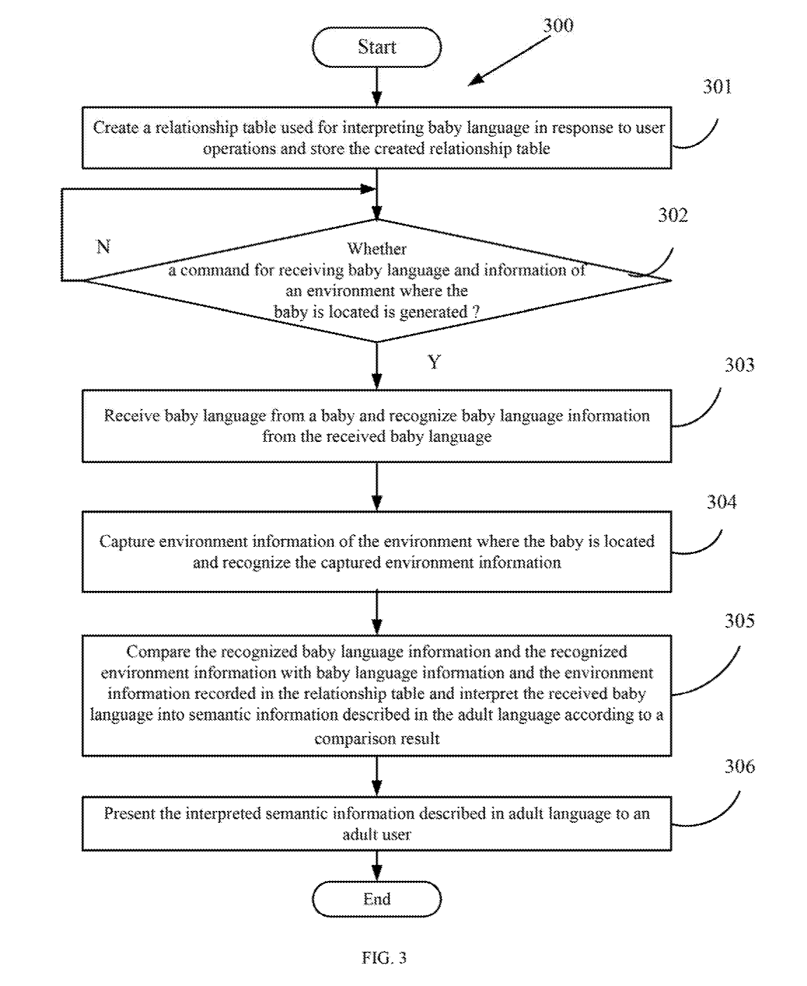

FIG. 3 is a flowchart of one embodiment of a baby language interpretation method in accordance with an example embodiment illustrated. The example method 300 is provided by way of example, as there are a variety of ways to carry out the method. The method 300 described below can be carried out using the configurations illustrated in FIGS. 1 and 2, for example, and various elements of these figures are referenced in explaining example method 300. Each block shown in FIG. 3 represents one or more processes, methods or subroutines, carried out in the exemplary method 300. Additionally, the illustrated order of blocks is by example only and the order of the blocks can change. The exemplary method 300 can begin at block 301. Depending on the embodiment, additional steps can be added, others removed, and the ordering of the steps can be changed.

At block 301, the creating module can create a relationship table used for interpreting baby language in response to user operations and store the created relationship table in the storage device.

At block 302, the command recognition module determines whether a command is generated for receiving baby language and information of an environment where the baby is located; if yes, the process goes to block 303; if no, the process goes back to block 302.

In the embodiment, the command for receiving baby language and environment information is generated when a user touches an icon or press button displayed on the touch screen.

At block 303, the sound receiving device receives baby language from a baby; and the sound recognition module recognizes baby language information from the received baby language.

In the embodiment, the sound recognition module 13 further marks the recognized baby language information with baby language keywords, such as quiet, noisy, or bang when something falls down.

At block 304, the environment capture device captures environment information of the environment where the baby is located upon receipt of the baby language, and the environment recognition module recognizes the captured environment information.

The environment recognition module further marks the recognized environment information with environment keywords. In the illustrated embodiment, the environment information includes information from the environment captured and information from the environment sound. That is, the environment capture device 26 includes the image capture device 25 and the sound receiving device 24; the environment recognition module 17 includes the image recognition module 14 and the sound recognition module 13.

Specifically, the image capture device 25 captures images of the surrounding environment where the baby is located when the baby makes the baby language; and the image recognition module 14 recognizes the environment information from the images captured by the image capture device 25. The image recognition module 14 further marks the recognized environment information with environment keywords. . The sound receiving device 24 further receives sound of the surrounding environment where the baby is located when the baby makes the baby language. The sound recognition module 13 recognizes the received sound of the surrounding environment and obtains environment information from the received sound of the surrounding environment, such as quiet or noisy. The sound recognition module 13 further marks the obtained environment information from the sound of the surrounding environment with environment keywords.

In an alternative embodiment, the image capture device 25 further captures baby body images of the baby when the baby makes the baby language. The image recognition module 14 recognizes the captured body images of the baby and obtains baby body language information from the captured baby body image. The image recognition module 14 further marks the obtained baby body language information with the baby body language keywords. For example, if there are tears on eyes of the baby in the captured baby body image, the image recognition module 14 marks the baby body language information with a keyword of “cry”.

At block 305, the interpretation module compares the recognized baby language information and the recognized environment information with the predefined baby language information and the predefined environment information recorded in the relationship table, and interprets the received baby language into semantic information described in the adult language according to a comparison result of the baby language information and the environment information.

In the embodiment, the interpretation module 15 compares keywords used to mark the obtained baby language information with keywords of the predefined baby language information recorded in the relationship table, and compares keywords used to mark the environment information with keywords of the predefined environment information recorded in the relationship table.

In an alternative embodiment, the interpretation module 15 further compares baby body language keywords used to mark the obtained baby body language information with keywords of the predefined baby body language information recorded in the relationship table. The interpretation module 15 interprets the received baby language into semantic information described via the adult language further according to a comparison result of the baby body language information.

At block 306, the presentation module presents the interpreted semantic information described in adult language to an adult user.

In one embodiment, the presentation module 16 presents the semantic information described in adult language to the adult user via voice messages. In other embodiments, the presentation module 16 presents the semantic information described in adult language to the adult user via text messages.

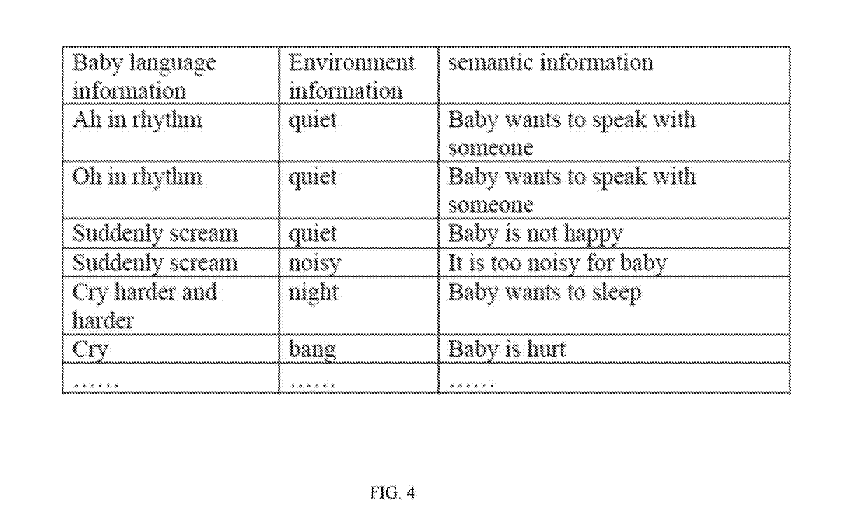

FIG. 4 shows a diagrammatic view of the relationship table. In the embodiment, the relationship table records baby language information, environment information, and semantic information described in adult language. Each of the baby language information, the environment information, and the semantic information includes more than one piece of information. Each piece of information of the semantic information is associated with a combination of one piece of information of the baby language information and one piece of information of the environment information.

In the illustrated embodiment, each piece of information of the baby language information is marked with a baby language keyword, such as, cry, laugh, prattle, oh, ah, scream, and so on. Each piece of information of the environment information is marked with an environment keyword, such as, quiet, noisy, daytime, night, toy, man, animal, and so on. The environment information includes image information of the environment and acoustic information of the environment. The semantic information described in adult language can include, but is not limited, “please talk to baby”, “baby wants to sleep”, “Baby is not happy”, “It is too noisy for baby”, “baby likes it”, “baby is hungry”, “baby does not like it”, and so on. In the examples as shown in FIG. 4, if the baby is prattling while the environment is quiet, at this moment, the “prattling” corresponds to “please talk to baby”; if the baby suddenly cries and the environment is noisy, at this moment, the “crying” corresponds to “It is too noisy for baby”.

The relationship table can be predefined according to user need.

In the embodiment, the interpretation system 10 determines that a voice from human, whose frequency and loudness are lower than a predefined value, is baby language. The interpretation system 10 determines an environment is noisy when a sound value of the environment is higher than a predefined value, and determines an environment is quite when a sound value of the environment is lower than a predefined value. The interpretation system 10 determines an environment is day or night according to light intensity of the environment. When the light intensity of the environment is higher than a predefined value, the interpretation system 10 determines it is day. When the light intensity of the environment is lower than a predefined value, the interpretation system 10 determines it is night.

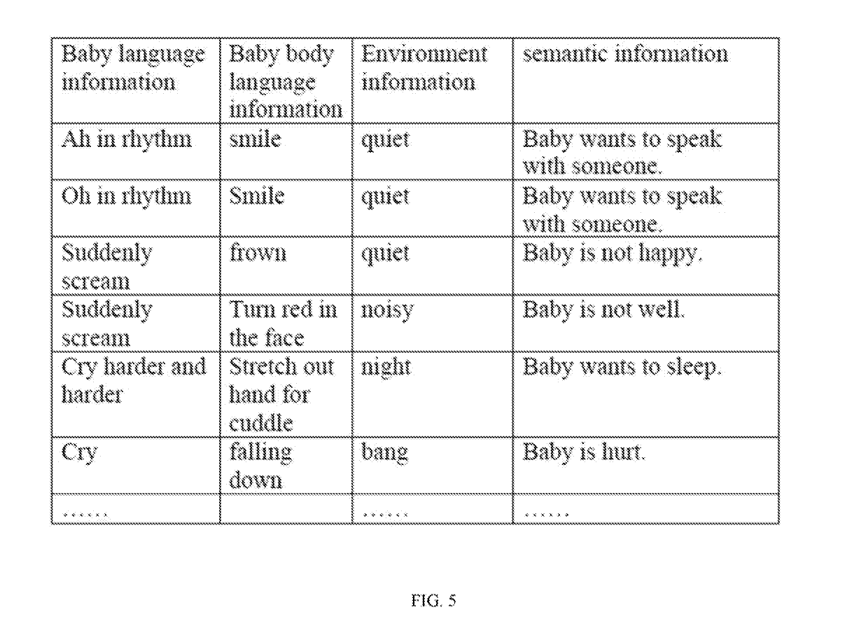

FIG. 5 shows a diagrammatic view of a relationship table according to a second embodiment. The relationship table further records baby body language information. The baby body language information includes more than one piece of information. Each piece of information of the baby body language information is marked with a baby body language keyword, such as, frown, climb, turning over to one side of the body, falling down, or encountering an object. In the illustrated embodiment, each piece of information of the semantic information is associated with a combination of one piece of information of the baby language information, one piece of information of the environment information, and one piece of information of the baby body language information. For example, if the baby gives a rhythmic sound “ah . . . ” and his hands are grasping while there is a toy in the environment surrounding the baby, at this moment, the sound “ah . . . ” corresponds to “baby wants to play toy”.

Kinds of the information recorded in the relationship table are set according to user needs. Each of the kinds of the information can be stored in a database form. For example, the baby language information is stored in a baby language database, the baby body language information is stored in a baby body language database, the environment information is stored in an environment database, the semantic information described in adult language is stored in a semantic database, and the relationships between the baby language database, the baby body language database, the environment database, and the semantic database are stored in a relationship database.

The embodiments shown and described above are only examples. Many details are often found in the art and many such details are therefore neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method for interpreting baby language being executed by at least one processor of an electronic device, the method comprising:
receiving, via a sound receiving device of the electronic device, baby language from a baby;
capturing, upon receipt of the baby language, via an environment capture device of the electronic device, environment information of an environment where the baby is located;
recognizing, via the at least one processor, baby language information from the received baby language;
recognizing, via the at least one processor, the captured environment information of the environment;
comparing, via the at least one processor, the recognized baby language information and the recognized environment information to predefined baby language information and predefined environment information recorded in a predefined relationship table, wherein the relationship table records predefined semantic information described in adult language, and each piece of information of the semantic information is associated with a combination of one piece of information of the baby language information and one piece of information of the environment information;
interpreting, via the at least one processor, the received baby language into the semantic information described in adult language according to a comparison result; and
presenting, via the at least one processor, the interpreted semantic information described in adult language to an adult user.

2. The method according to claim 1, further comprising:
marking the recognized baby language information with baby language keywords.

3. The method according to claim 1, further comprising:
marking the recognized environment information with environment keywords.

4. The method according to claim 1, wherein the relationship table further records predefined baby body language information, and each piece of information of the semantic information is associated with a combination of one piece of information of the baby language information, one piece of information of the environment information, and one piece of information of the baby body language information.

5. The method according to claim 4, further comprising:
capturing, via an image capture device of the electronic device, body images of the baby upon receipt of the baby language;
recognizing, via the at least one processor, the baby body language information from the captured body images;
comparing, via the at least one processor, the recognized baby body language information to the baby body language information of the relationship table; and
interpreting, via the at least one processor, the received baby language into the semantic information described in adult language according to a comparison result of the baby body language information.

6. The method according to claim 4, further comprising:
creating the predefined relationship table in response to user operations.

7. The method according to claim 1, further comprising:
receiving, via a sound receiving device of the electronic device, environment sound of the environment where the baby is located upon receipt of the baby language;
recognizing, via the at least one processor, the environment information from the received environment sound.

8. The method according to claim 7, wherein the recognized environment information is marked with environment keywords.

9. The method according to claim 1, wherein the environment information comprises information from environment image and/or information from environment sound, and “capturing, via an environment capture device of the electronic device, environment information of an environment where the baby is located upon receipt of the baby language” comprises:
capturing images and/or receiving sound of the environment where the baby is located upon receipt of the baby language.

10. An electronic device comprising:
a sound receiving device, for receiving baby language from a baby;
an environment capture device, for capturing, upon receipt of the baby language, environment information of an environment where the baby is located;
a processor; and
a storage device that stores one or more programs which, when executed by the processor, cause the processor to:
recognize, via the processor, baby language information from the received baby language;
recognize, via the processor, the captured environment information of the environment;
compare, via the processor, the recognized baby language information and the recognized environment information to predefined baby language information and predefined environment information recorded in a predefined relationship table, wherein the relationship table records predefined semantic information described in adult language, and each piece of information of the semantic information is associated with a combination of one piece of information of the baby language information and one piece of information of the environment information;
interpret, via the processor, the received baby language into the semantic information described in adult language according to a comparison result; and
present, via the processor, the interpreted semantic information described in adult language to an adult user.

11. The electronic device according to claim 10, wherein the recognized baby language information is marked with baby language keywords.

12. The electronic device according to claim 10, wherein the recognized environment information is marked with environment keywords.

13. The electronic device according to claim 10, wherein the relationship table further records predefined baby body language information, and each piece of information of the semantic information is associated with a combination of one piece of information of the baby language information, one piece of information of the environment information, and one piece of information of the baby body language information.

14. The electronic device according to claim 13, further comprising an image capture device, wherein the image capture device captures body images of the baby upon receipt of the baby language; and the processor is further caused to:
recognize baby body language information from the captured body images;
compare the recognized baby body language information with the baby body language information of the relationship table; and
interpret the received baby language into the semantic information described in adult language according to a comparison result of the baby body language information.

15. The electronic device according to claim 10, wherein the sound receiving device receives sound of the surrounding environment where the baby is located upon receipt of the baby language; and the processor is caused to recognize the environment information from the received environment sound.

16. A non-transitory storage medium having stored thereon instructions that, when executed by a processor of an electronic device, causes the processor to perform a method for interpreting baby language, wherein the method comprises:
receiving, via a sound receiving device of the electronic device, baby language from a baby;
capturing, upon receipt of the baby language, via an environment capture device of the electronic device, environment information of an environment where the baby is located upon receipt of the baby language;
recognizing, via the at least one processor, baby language information from the received baby language;
recognizing, via the at least one processor, the captured environment information of the environment;
comparing, via the at least one processor, the recognized baby language information and the recognized environment information to predefined baby language information and predefined environment information recorded in a predefined relationship table, wherein the relationship table records predefined semantic information described in adult language, and each piece of information of the semantic information is associated with a combination of one piece of information of the baby language information and one piece of information of the environment information;
interpreting, via the at least one processor, the received baby language into the semantic information described in adult language according to a comparison result; and
presenting, via the at least one processor, the interpreted semantic information described in adult language to an adult user.

17. The non-transitory storage medium according to claim 16, wherein the method further comprises:
marking the recognized baby language information with baby language keywords.

18. The non-transitory storage medium according to claim 16, wherein the method further comprises:
marking the recognized environment information with environment keywords.

19. The non-transitory storage medium according to claim 16, wherein the method further comprises:
receiving, via a sound receiving device of the electronic device, sound of the surrounding environment where the baby is located upon receipt of the baby language;
recognizing, via the at least one processor, the environment information from the received environment sound.

20. The non-transitory storage medium according to claim 19, wherein the recognized environment information is marked with environment keywords.
